(19) United States
(12) Patent Application Publication
(10) Pub. No.: US 2016/0152005 A1
(43) Pub. Date: Jun. 2, 2016

(54) HYBRID PLATED COMPOSITE STACK

(71) Applicant: UNITED TECHNOLOGIES CORPORATION, Farmington, CT (US)

(72) Inventors: James T. ROACH, Vernon, CT (US); Grant O. COOK, Spring, TX (US)

(21) Appl. No.: 14/903,908

(22) PCT Filed: Jul. 9, 2014
(86) PCT No.: PCT/US14/45932

§ 371 Date: Jan. 8, 2016

Related U.S. Application Data
(60) Provisional application No. 61/844,108, filed on Jul. 9, 2013.

(51) Int. Cl. B32B 15/04; B32B 37/12; B32B 37/14

(52) U.S. Cl. CPC B32B 15/04; B32B 37/14; B32B 37/12

(57) ABSTRACT

A composite laminate component is disclosed. The composite laminate component may comprise a composite laminate including a plurality of sub-laminates, and a metallic layer encapsulating one or more of the sub-laminates. The sub-laminates may be joined by a bond between the metallic layers.

### CROSS-REFERENCE TO RELATED APPLICATIONS

This application claims priority under 35 U.S.C. §119(e) to U.S. Provisional Patent Application Serial Number 61/844,108 filed on Jul. 9, 2013.

### FIELD OF THE DISCLOSURE

The present disclosure generally relates to composite laminate components. More specifically, this disclosure relates to composite laminate components plated with metallic layers.

### BACKGROUND

Composite laminates are attractive materials for numerous applications and consist of high-strength layers of fabric (or lamina) embedded in a polymeric, ceramic, or metal matrix. Composite laminates formed in a polymer matrix may be referred to as polymer matrix composites (PMCs), those formed in a ceramic matrix may be referred to as ceramic matrix composites (CMCs), and those formed in a metal matrix may be referred to as metal matrix composite (MMCs). The high-strength lamina may be formed from woven fibers of carbon, glass, aramid, boron, or any other high-strength fiber. Although composite laminates are associated with high in-plane stiffness (i.e., in the plane of the fabric layer), the weak interfacial strength between the lamina and their consequent tendency towards de-lamination (i.e., the pulling apart of individual lamina in the laminate) has precluded the use of these materials in some applications. In addition, the outer-most lamina may be more subject to a wide array of environmental effects such as ultraviolet (UV) damage, erosion, and handling damage.

Clearly, there is a need for systems which improve the resistance of composite laminates towards delamination as well as the structural resilience of composite laminates as a whole.

### SUMMARY OF THE DISCLOSURE

In accordance with one aspect of the present disclosure, a composite laminate component is disclosed. The composite laminate component may comprise a composite laminate, and a metallic layer applied to at least one surface of the composite laminate.

In another refinement, the composite laminate may be a polymer matrix composite.

In another refinement, the composite laminate may be a metal matrix composite.

In another refinement, the composite laminate may be a ceramic matrix composite.

In another refinement, the metallic layer may encapsulate the composite laminate.

In another refinement, the composite laminate may include a plurality of sub-laminates, and the metallic layer may be applied at an interface between at least two of the sub-laminates.

In another refinement, the composite laminate may include a plurality of sub-laminates, and the metallic layer may be applied to a surface of each of the sub-laminates that lies at an interface with another sub-laminate.

In another refinement, the metallic layers at the interface between the sub-laminates may be joined by bonds.

In another refinement, the composite laminate may include a plurality of sub-laminates, and a metallic layer may encapsulate each of the sub-laminates.

In another refinement, the metallic layers encapsulating the sub-laminates may be joined by bonds.

In another refinement, the composite laminate component may be further encapsulated in a metallic layer.

In another refinement, the composite laminate component may be further encapsulated in a polymeric material.

In accordance with another aspect of the present disclosure, a composite laminate component is disclosed. The composite laminate component may comprise a composite laminate including a plurality of sub-laminates, and a metallic layer encapsulating at least one of the sub-laminates.

In another refinement, a metallic layer may encapsulate each of the sub-laminates.

In another refinement, the sub-laminates may be joined by bonds between the metallic layers.

In another refinement, the bonds may be formed by transient liquid phase bonding.

In another refinement, the bonds may be formed by adhesive bonding.

In accordance with another aspect of the present disclosure, a method for fabricating a composite laminate component is disclosed. The method may comprise: 1) providing a plurality of sub-laminates, 2) applying a metallic layer to a surface of at least one of the sub-laminates, 3) stacking the sub-laminates, and 4) joining the sub-laminates to provide the composite laminate component.

In another refinement, applying a metallic layer to a surface of at least one of the sub-laminates may comprise encapsulating each of the sub-laminates in a metallic layer.

In another refinement, joining the sub-laminates may comprise forming bonds between the metallic layers by transient liquid phase bonding or adhesive bonding.

These and other aspects and features of the present disclosure will be more readily understood when read in conjunction with the accompanying drawings.

### BRIEF DESCRIPTION OF THE DRAWINGS

FIG. 1 is a front view of a hybrid composite laminate component constructed in accordance with the present disclosure.

FIG. 2 is a cross-sectional view of the hybrid composite laminate component of FIG. 1 taken along the line 2-2 of FIG. 1, constructed in accordance with the present disclosure.

FIG. 3 is a cross-sectional view of a hybrid composite laminate component similar to FIG. 2, but having metallic layers applied at the interface of sub-laminates, constructed in accordance with the present disclosure.

FIG. 4 is a cross-sectional view of the hybrid composite laminate component of FIG. 3, but being joined by a bond between the metallic layers, constructed in accordance with the present disclosure.

FIG. 5 is a cross-sectional view of a hybrid composite laminate component similar to FIG. 4, but having the sub-laminates encapsulated in a plating layer, constructed in accordance with the present disclosure.

FIG. 6 is a cross-sectional view of the hybrid composite laminate component of FIG. 5 encapsulated in a metal plating layer, constructed in accordance with the present disclosure.

FIG. 7 is a cross-sectional view of the hybrid composite laminate component of FIG. 5, but coated with a polymeric material, constructed in accordance with the present disclosure.

FIG. 8 is flow chart illustrating steps for fabricating the hybrid composite laminate components in accordance with methods of the present disclosure.

It should be understood that the drawings are not necessarily drawn to scale and that the disclosed embodiments are sometimes illustrated schematically and in partial views. It is to be further appreciated that the following detailed description is merely exemplary in nature and is not intended to limit the invention or the application and uses thereof. In this regard, it is to be additionally appreciated that the described embodiment is not limited to use with certain applications. Hence, although the present disclosure is, for convenience of explanation, depicted and described as certain illustrative embodiments, it will be appreciated that it can be implemented in various other types of embodiments and in various other systems and environments.

### DETAILED DESCRIPTION

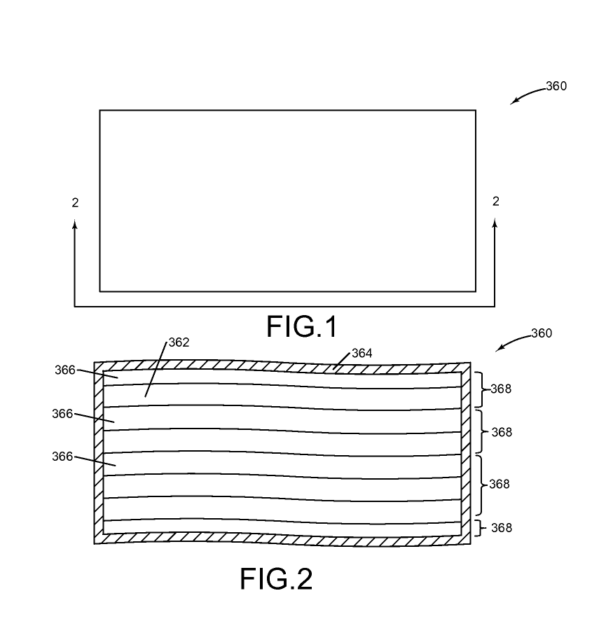

Referring now to FIGS. 1 and 2, a hybrid composite laminate component 360 is shown. The hybrid composite laminate component 360 may consist of a composite laminate 362 encapsulated in one or more metallic layers 364. The composite laminate 362 may consist of stacked layers of laminae 366, and groups of two or more laminae 366 may form a sub-laminate 368, as shown. The metallic layer 364 encapsulating the composite laminate 362 may assist in resisting delamination (i.e., the peeling away of the lamina 366) while protecting the outer surfaces of the composite laminate 362 from environmental damage such as erosion, UV damage, foreign-object damage, impact damage, and thermal damage.

Each of the lamina 366 may consist of a woven fabric layer of reinforcing fibers such as, but not limited to, carbon, glass, aramid, or boron fibers which provide the lamina 366 with high strength in the plane of the fabric layers. In addition, each of the woven fabric layers may have different thicknesses, different orientations with respect to one another, and different material compositions. The lamina 366 may be embedded in a matrix of polymer, ceramic, or metal to adhesively bind the lamina 366 together to form a PMC, a CMC, or an MMC, respectively. If the matrix is formed from a polymer, it may consist of one or more thermoplastic or thermoset materials. Suitable thermoplastic materials for the polymer matrix may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, combinations thereof, or any of the foregoing with optional reinforcement with carbon or glass fiber. Suitable thermoset materials may include, but are not limited to, condensations polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silcones (thermoset), or any of the foregoing with optional reinforcement with carbon or glass fibers. The metallic layer 364 may consist of any platable material such as, but not limited to, nickel, cobalt, copper, iron, gold, silver, palladium, chromium, zinc, tin, cadmium, and alloys with any of the foregoing elements comprising at least 50 wt. % of the alloy, or combinations thereof.

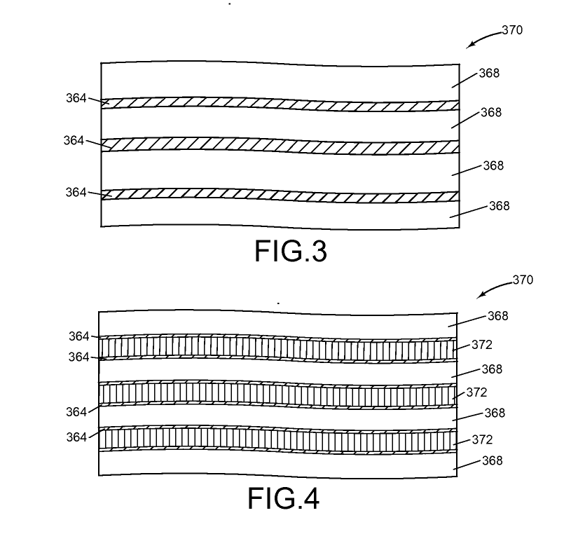

As an alternative arrangement, a hybrid composite laminate component 370 having one or more metallic layers 364 between the sub-laminates 368 is shown in FIG. 3. More specifically, the sub-laminates 368 forming the component 370 may be plated with one or more metallic layers 364 on a surface which lies at the interface of two sub-laminates 368 in the stack. Alternatively, the metallic layer 364 may be similarly applied to the interfacing surfaces of one or more laminae 366 in the stack (not shown). As the metallic layers 364 may prevent de-lamination and impart the component 370 with enhanced structural resilience, selected sub-laminates 368 and/or selected laminae 366 may be plated with the metallic layer 364 as necessary to tailor the desired resistance of the component 370 towards delamination and/or to meet component structural requirements.

To form the component 370, the sub-laminates 368 (plated and non-plated) may be assembled in a stack and joined to form a unitary structure using a conventional composite fabrication technique such as, but not limited to, compression molding and resin transfer molding. Alternatively, metallic layers 364 at the interface of the sub-laminates 368 (or at the interface of the lamina 366) may be joined to form a bond 372 at the interface of the sub-laminates 368 (or at the interface of the laminae 366), as shown in FIG. 4. The metallic layers 364 may be joined by a suitable method apparent to those having ordinary skill in the art such as transient liquid phase (TLP) bonding or adhesive bonding. Other processes, such as brazing or diffusion bonding may also be employed if the composite laminate is a CMC or an MMC. Once formed, the entire body or selected regions of the hybrid composite laminate component 370 may optionally be encapsulated in one or more metallic layers 364 to provide additional structural resilience and/or resistance against delamination. As another optional arrangement, the entire body or selected regions of the hybrid composite laminate component 370 may be coated with a polymer coating to provide a non-conductive surface and/or to provide a polymeric-appearing surface.

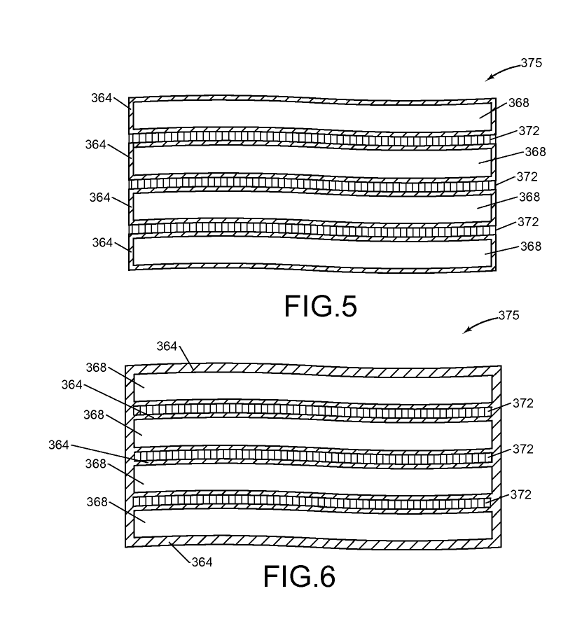

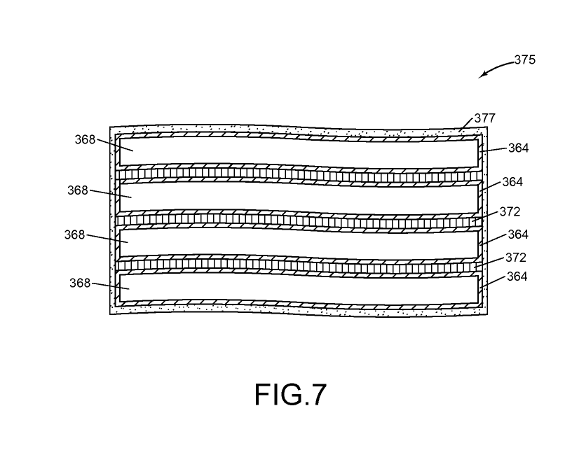

As shown in FIG. 5, one or more selected sub-laminates 368 may be fully encapsulated in one or more metallic layers 364 to form a hybrid composite laminate component 375 having enhanced resistance towards delamination. To form the component 375, the sub-laminates 368 (both encapsulated and non-encapsulated) may be assembled in a stack to form a desired shape and a bond 372 may be formed between the encapsulated sub-laminates by a suitable metal joining technique such as TLP bonding or adhesive bonding, as will be understood by those having ordinary skill in the art. Alternatively, the sub-laminates 368 (both encapsulated and non-encapsulated) may be assembled in a stack having a desired shape and joined to form a unitary structure using a conventional composite fabrication technique such as, but not limited to, compression molding and resin transfer molding. Once formed, the entire body or selected regions of the component 375 may optionally be further encapsulated in one or more metallic layers 364, as shown in FIG. 6, to further impart the component with increased structural capability and resistance against delamination. As yet another optional arrangement, the entire body or selected regions of the component 375 may be coated with a polymeric material 377, as shown in FIG. 7, to provide a non-conductive and/or polymeric-appearing surface.

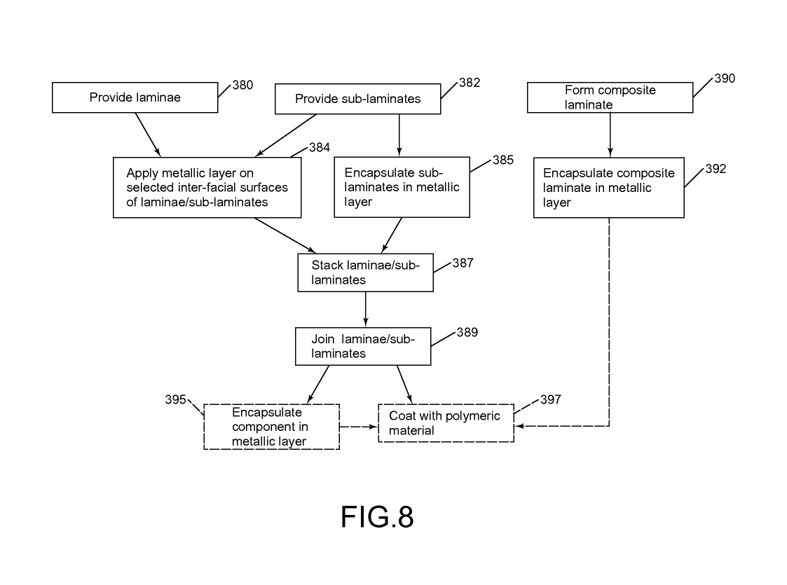

A series of steps which may be performed for the fabrication of the hybrid composite laminate components of the present disclosure are depicted in FIG. 8. Beginning with a block 380 and 382, laminae 366 or sub-laminates 368 (which may be assembled from the laminae 366) may be provided. According to a next block 384, metallic layers 364 may be selectively applied to the interfacial surfaces of the laminae 366 and/or the sub-laminates 368 (see FIG. 3). If the laminae 366 and the sub-laminates 368 are embedded in a polymer matrix, the metallic layers 364 may be applied using well-known metal deposition processes (i.e, electrolytic plating, electroless plating) after suitable activation and metallization of the selected interfacial surfaces of the laminae and/or sub-laminates using established techniques in the industry. In addition, the metallic layers 364 may also be applied by other metal deposition methods such as, but not limited to, chemical vapor deposition, physical vapor deposition, cold spraying, plasma spraying, and powder metal deposition. However, if the laminae 366 or the sub-laminates 368 are embedded in a ceramic matrix, the metallic layers 364 may be applied to selected interfacial surfaces by partial transient liquid phase (PTLP) bonding or another suitable method selected by a skilled artisan. If the laminae 366 or the sub-laminates 368 are embedded in a metallic matrix, the metallic layers 364 may be applied to the selected interfacial surfaces using brazing or another method chosen by a skilled artisan. The thickness of the metallic layers 364 on the interfacial surfaces of the laminae 366 or the sub-laminates 368 may be in the range of about 0.00001 to about 0.02 inches, although other thickness ranges may also apply. The thicknesses of the metallic layers 364 may also be selectively adjusted in certain areas to provide desired surface characteristics and/or to optimize properties in certain areas such as fire resistance, erosion resistance, or resistance against delamination. Such selective thickening may be achieved using conventional methods such a surface masking and/or tailored racking tools such as shields, current thieves, or conformal anodes.

Selected sub-laminates 368 may also be encapsulated in a metallic layer according to a block 385 (see FIG. 5). Metal deposition on the sub-laminates for the block 385 may be achieved as described for the block 384 above. The thickness of the metallic layer 364 for sub-laminate encapsulation may be in the range of about 0.0001 inches to about 0.05 inches, although other thickness ranges may also apply. Moreover, the metallic layer thickness may be selectively adjusted in selected regions using masking and/or tailored racking techniques as described above. According to blocks 387 and 389, the laminae 366 (including both the plated and the non-plated laminae) and/or the sub-laminates 368 (including sub-laminates plated on inter-facial surfaces, encapsulated sub-laminates, and/or non-plated sub-laminates) may be assembled in a stack and joined to form the component (e.g., components 370 and 375) having a desired shape. The block 389 may be achieved using a conventional composite fabrication technique (e.g., compression molding or resin transfer molding) or by forming a bond between the metallic layers 364 using a metal joining technique apparent to those having ordinary skill in the art such as TLP bonding or adhesive bonding. Brazing, ultrasonic welding, laser welding, friction welding, friction-stir welding, traditional welding, or diffusion bonding may also be suitable metal joining processes if the matrix is formed from ceramic or metal.

Following the block 389, the formed hybrid composite components (e.g., components 370 and 375) may be optionally encapsulated in a metallic layer 364 according to a block 395 (see FIG. 6). The encapsulating metallic layer may be deposited as described above for the block 384 and it may have a thickness in the range of about 0.001 inches to about 0.02 inches, although other thicknesses may also apply. Selective thickening of the encapsulating metallic layer may also be achieved as described above to provide the option to finish the surface more aggressively to meet tight tolerances or surface finish requirements or to impart the component with desired properties such as enhanced erosion resistance, increased structural support, increased fire resistance, or increased resistance towards delamination. According to an optional block 397, the formed hybrid composite component may optionally be encapsulated in a polymeric material 377 (see FIG. 7) after the block 389 or after the block 395 to provide a non-conductive and/or polymeric-appearing surface. The polymeric material 377 may be applied by a conventional process apparent to those having ordinary skill in the art such as, but not limited to, spray coating or dip coating.

Alternatively, the composite laminate 362 (see FIG. 2) may be directly formed from stacked laminae in a desired shape according to a block 390, as shown. The block 390 may be carried out using a composite molding technique apparent to those having ordinary skill in the art such as, but not limited to, injection molding, compression molding, blow molding, additive manufacturing (liquid bed, powder bed, deposition processes), or composite layup (autoclave, compression, or liquid molding). The entire body or selected regions of the composite laminate 362 may then be encapsulated in a metallic layer 364 according to a block 392. The block 392 may be carried out using the metal deposition techniques described above for the block 384. The metallic layer 364 encapsulating the composite laminate 362 may have a thickness in the range of about 0.001 inches to about 0.02 inches and, if desired, may be selectively thickened in certain regions as described above. To provide the formed component with a non-conductive surface and/or a polymeric-appearing surface, the component may optionally be coated with a polymeric material according to the block 397.

It is further noted that segments of composite laminate structures and/or hybrid composite laminate structures may be formed and later joined to form a unitary structure by encapsulation in a metallic layer and/or by joining metallic layers by conventional processes such as TLP bonding, adhesive bonding, or various welding processes (e.g., ultrasonic, friction, friction-stir). In this way, components having complex structures and/or mounting features may be accessed by joining segments having simpler structures.

### INDUSTRIAL APPLICABILITY

From the foregoing, it can therefore be seen that the present disclosure can find industrial applicability in many situations, including, but not limited to, industries requiring light-weight and high-strength composite laminate components having improved resistance against delamination. The technology as disclosed herein provides composite laminate components and/or sub-laminates encapsulated in one or more metallic layers to increase the strength of the component, resist delamination, and improve the resistance of the component against environmental effects such as fire, erosion, or foreign-object damage. Furthermore, as disclosed herein, metallic layers may be introduced on the surface of selected laminae and/or sub-laminates to provide delamination-resistant hybrid composite structures having metallic layers at the interface of laminae and/or sub-laminates. In addition, selective thickening of the metallic layers may be exploited to optimize surface properties such as fire resistance, erosion resistance, and delamination resistance in selected areas without adding undue weight to the part. The technology as disclosed herein may find wide industrial applicability in a wide range of areas including, but not limited to, aerospace, automotive, and sporting industries.

What is claimed is:

1. A composite laminate component, comprising:
a composite laminate; and
a metallic layer applied to at least one surface of the composite laminate.

2. The composite laminate component of claim 1, wherein the composite laminate is a polymer matrix composite.

3. The composite laminate component of claim 1, wherein the composite laminate is a metal matrix composite.

4. The composite laminate component of claim 1, wherein the composite laminate is a ceramic matrix composite.

5. The composite laminate component of claim 1, wherein the metallic layer encapsulates the composite laminate.

6. The composite laminate component of claim 1, wherein the composite laminate includes a plurality of sub-laminates, and wherein the metallic layer is applied at an interface between at least two of the sub-laminates.

7. The composite laminate component of claim 1, wherein the composite laminate includes a plurality of sub-laminates, and wherein the metallic layer is applied to a surface of each of the sub-laminates that lies at an interface with another sub-laminate.

8. The composite laminate component of claim 7, wherein the metallic layers at the interface between the sub-laminates are joined by bonds.

9. The composite laminate component of claim 1, wherein the composite laminate includes a plurality of sub-laminates, and wherein a metallic layer encapsulates each of the sub-laminates.

10. The composite laminate component of claim 9, wherein the metallic layers encapsulating the sub-laminates are joined by bonds.

11. The composite laminate component of claim 10, wherein the composite laminate component is further encapsulated in a metallic layer.

12. The composite laminate component of claim 10, wherein the composite laminate component is further encapsulated in a polymeric material.

13. A composite laminate component, comprising:
a composite laminate including a plurality of sub-laminates; and
a metallic layer encapsulating at least one of the sub-laminates.

14. The composite laminate component of claim 13, wherein a metallic layer encapsulates each of the sub-laminates.

15. The composite laminate component of claim 14, wherein the sub-laminates are joined by bonds between the metallic layers.

16. The composite laminate component of claim 15, wherein the bonds are formed by transient liquid phase bonding.

17. The composite laminate component of claim 15, wherein the bonds are formed by adhesive bonding.

18. A method for fabricating a composite laminate component, comprising:
providing a plurality of sub-laminates; and
applying a metallic layer to a surface of at least one of the sub-laminates;
stacking the sub-laminates; and
joining the sub-laminates to provide the composite laminate component.

19. The method of claim 18, wherein applying a metallic layer to a surface of at least one of the sub-laminates comprises encapsulating each of the sub-laminates in a metallic layer.

20. The method of claim 19, wherein joining the sub-laminates comprises forming bonds between the metallic layers by transient liquid phase bonding or adhesive bonding.
